(19) United States
(12) Patent Application Publication
(10) Pub. No.: US 2003/0035875 A1
(43) Pub. Date: Feb. 20, 2003

(54) Composition for improving the taste and sweetness profile of beverages having intense sweeteners

(76) Inventors: Joel I. Dulebohn, Lansing, MI (US); Lavaughn M. Hill, Chicago, IL (US)

Correspondence Address: QUARLES & BRADY LLP, 411 E. WISCONSIN AVENUE, SUITE 2040, MILWAUKEE, WI, 53202-4497, US

(21) Appl. No.: 10/108,839

(22) Filed: Mar. 28, 2002

Related U.S. Application Data
(60) Provisional application No. 60/281,217, filed on Apr. 3, 2001.

(51) Int. Cl. A23L 1/236

(52) U.S. Cl. 426/548

(57) ABSTRACT

A composition including: an intense sweetener, a gum; a food additive comprising an amino acid, an acid selected from organic acids, inorganic acids and mixtures thereof, and a metal ion; and an agent that masks or blocks the taste of bitter substances is disclosed. The composition may be incorporated into a beverage (such as a carbonated soft drink and flavored water). The components in the composition other than the intense sweetener eliminate the off flavors due to the intense sweetener. The components in the composition other than the intense sweetener improve the shelf life, enhance the mouth-feel, eliminate the off flavors of the intense sweetener, and improves the time-intensity profile of a beverage or other oral use product.

### CROSS-REFERENCES TO RELATED APPLICATIONS

This application claims the benefit of U.S. Provisional Patent Application No. 60/281,217 filed Apr. 3, 2001.

### STATEMENT REGARDING FEDERALLY SPONSORED RESEARCH

Not Applicable.

### BACKGROUND OF THE INVENTION

1. Field of the Invention

This invention relates to the field of sweetening compositions for oral use, and more particularly to sweetening compositions including an intense sweetener wherein the sweetening composition further includes other ingredients that help improve the taste and long-term sweetness profile of beverages, such as carbonated soft drinks and flavored waters, when the beverages are sweetened with the sweetening compositions including an intense sweetener.

2. Description of the Related Art

Intense sweeteners are well known in the art and are widely used in place of sugar in many low calorie and/or noncariogenic compositions. Intense sweeteners are natural or synthetic compounds which have a sweetening intensity greater than that of sugar (sucrose). Because intense sweeteners provide greater sweetening capacity than sugar, smaller amounts of the intense sweeteners will provide sweetening intensity equivalent to larger amounts of sugar. Thus, intense sweeteners can provide compositions which have decreased caloric value, as compared to sugar-sweetened compositions, far lower amounts of the intense sweetener are required to achieve optimum sweetness in the composition.

Intense sweeteners have a wide range of chemically distinct structures and, hence, possess varying properties. These intense sweetener compounds include proteins such as thaumatin, dipeptides such as N-L-alpha-aspartyl-L-phenylalanine 1-methyl ester (aspartame) and dihydrochalcones. Each of these compounds has a distinct sweetening intensity as compared to sucrose and this sweetening intensity is well documented. See, for example, U.S. Pat. No. 5,013,716, which is incorporated herein by reference.

There is a demand in the beverage industry to produce diet sodas having a time-intensity profile of diet soda similar to sugar soda, a reduction of off-flavors due to the high intensity sweeteners, an improved mouth-feel, and an increased shelf life. Individual Intense sweeteners have been used for years in diet beverages. However, the beverage industry is leaning toward using a blend of high intensity sweeteners as studies have found that single sweeteners tend to have more chemical and sweet aftertaste (see, e.g., Food Technology, November 1999 at page 86). One advantage of using a blend of high intensity sweeteners is the time-intensity profile is closer to sugar. The blends of high intensity sweeteners also have a synergistic effect on sweetness. One can use less of a blend than one high intensity sweetener alone. Although various blends of intense sweeteners have been proposed (see, e.g., U.S. Pat. Nos. 4,536,396 and 4,495,170), a recent research study found that blends of aspartame (N-L-α-aspartyl-L-phenylalanine 1-methyl ester), and acesulfame K (potassium salt of 6-methyl-1,2,3-oxathiazin-4(3H)-one-2,2-dioxide) achieve the most sugar-like taste profile of all common sweetener blends. Background information on various blends of aspartame and acesulfame K, and on the use of these blends in beverages can be found in U.S. Pat. Nos. 6,245,373, 5,976,602, 5,474,791 and 4,158,068, which are incorporated herein by reference.

Each high intensity sweetener has it own advantages and disadvantages. For example, aspartame is about 180 times sweeter than sugar, but it is only stable from 6 months to one year in a low pH beverage. Beverages with aspartame must increase the initial amount of aspartame in the beverage to compensate for loss of sweetness over time. There are also off flavors of the beverage due to aspartame. The sweetness time-intensity profile takes longer and lasts longer than sugar. Acesulfame K is 200 times sweeter than sugar, and is stable for at least one year. The time-intensity profile is faster and shorter than sugar. The main off flavor (typically bitterness) of acesulfame K is due to the potassium ion in acesulfame K. The potassium off flavor has limited the use of acesulfame K in many applications.

There are several beverages that contain a blend of acesulfame K and aspartame but the ratio of acesulfame K to aspartame is low and is around 10% acesulfame K and 90% aspartame. This increases the shelf life only about one month, and gives a slightly better time-intensity profile. The optimal ratio of acesulfame K and aspartame for time-intensity profile is a 1:1 blend. This blend has a time-intensity profile similar to sucrose. For shelf life stability, the best blend is a ratio of acesulfame K and aspartame of 70:30. At this ratio, the beverage is stable for over one year. The disadvantage is that using acesulfame K at this level causes too many off flavors and the beverage is not acceptable.

Therefore, there is a need for a composition that allows a blend of acesulfame K and aspartame to be used in a beverage at any ratio of acesulfame K to aspartame without the off flavors due to the acesulfame K or aspartame. More generally, there is a need for a sweetening composition for oral use wherein the composition includes an intense sweetener and other ingredients that help improve the taste and long-term sweetness profile of the oral use product.

### SUMMARY OF THE INVENTION

The foregoing needs are met by a sweetening composition according to the invention for oral use including (i) an intense sweetener comprising a mixture of aspartame and acesulfame K; and (ii) a food additive comprising an amino acid, an acid selected from organic acids, inorganic acids and mixtures thereof, and a metal ion. The foregoing needs are also met by another sweetening composition according to the invention for oral use including (i) an intense sweetener; (ii) a food additive comprising an amino acid, an acid selected from organic acids, inorganic acids and mixtures thereof, and a metal ion, and (iii) an agent that masks or blocks the taste of bitter substances. The foregoing needs are also met by yet another sweetening composition according to the invention for oral use including (i) an intense sweetener; (ii) a food additive comprising an amino acid, an acid selected from organic acids, inorganic acids and mixtures thereof, and a metal ion, and (iii) a gum.

In one example embodiment, any of these compositions according to the invention may be incorporated into a beverage (such as a carbonated soft drink or a flavored water) in order to provide sweetness without the off flavors due to the intense sweetener in the composition. The sweetening compositions improve the shelf life, enhance the mouth-feel, eliminate any off flavors due of the high intensity sweeteners, and improve the time-intensity profile of the beverage.

It is believed that the food additive in the sweetening composition acts as a bitter blocker and enhances the mouth-feel of a beverage or other oral use product including the sweetening composition. It is also believed that the gum in the sweetening composition increases the mouth-feel, but lowers the sweetness and flavor profile of a beverage or other oral use product including the sweetening composition. It has been noted that there is a synergistic effect when the food additive is used in combination with the gum. In other words, there is an enhancement of mouth-feel with a blend of the food additive and the gum, compared to the food additive and the gum being used separately. Also, the combination of the food additive and the gum prevents the loss of sweetness and flavor profile in a beverage or other oral use product including the sweetening composition.

The agent that masks or blocks the taste of bitter substances is used to enhance the flavor of a beverage or other oral use product including the sweetening composition and to block the bitter taste of bitter substances in the intense sweetener (such metal ions, e.g., the potassium ion from acesulfame K). The agent that masks or blocks the taste of bitter substances and the food additive have the synergistic effect of blocking the off flavors like potassium and enhancing the flavors of a beverage or other oral use product including the sweetening composition.

Therefore, it is an advantage of the present invention to provide a sweetening composition having an intense sweetener that may be incorporated into a beverage or other oral use product in order to improve the shelf life, enhance the mouth-feel, eliminate the off flavors of high intensity sweeteners, and improve the time-intensity profile of the high intensity sweetener and blends of high intensity sweeteners in the beverage.

It is another advantage of the present invention to provide a sweetening composition that will allow a beverage to have a blend of acesulfame K and aspartame at a ratio of acesulfame K and aspartame from 5:95 to 100:0, without the beverage having off flavors due to the acesulfame K and aspartame.

It is another advantage of the present invention to provide a beverage with at least one high intensity sweetener and a composition including (i) a gum, (ii) a food additive comprising an amino acid, an acid selected from organic acids, inorganic acids and mixtures thereof, and a metal ion, and (iii) an agent that masks or blocks the taste of bitter substances wherein the composition gives the beverage improved shelf life, enhanced mouth-feel, limited off flavors from the high intensity sweeteners, and an improved time-intensity profile of the high intensity sweetener(s).

These and other features and advantages of the invention will become better understood upon consideration of the following detailed description and appended claims.

### DETAILED DESCRIPTION OF THE INVENTION

In one embodiment, the present invention is a sweetening composition for oral use including (i) an intense sweetener comprising a mixture of aspartame and acesulfame K; and (ii) a food additive comprising an amino acid, an acid selected from organic acids, inorganic acids and mixtures thereof, and a metal ion. In another embodiment, the present invention is a sweetening composition for oral use including (i) an intense sweetener; (ii) a food additive comprising an amino acid, an acid selected from organic acids, inorganic acids and mixtures thereof, and a metal ion, and (iii) an agent that masks or blocks the taste of bitter substances. In yet another embodiment, the present invention is a sweetening composition for oral use including (i) an intense sweetener; (ii) a food additive comprising an amino acid, an acid selected from organic acids, inorganic acids and mixtures thereof, and a metal ion, and (iii) a gum.

Any of the embodiments of the sweetening composition may be incorporated into a beverage. The components in the sweetening composition other than the intense sweetener act to eliminate the off flavors due to the intense sweeteners (acesulfame K and/or aspartame). The components in the sweetening composition other than the intense sweetener also act to improve the shelf life, enhance the mouth-feel, eliminate the off flavors of the intense sweeteners, and improve the time-intensity profile of the beverage.

The intense sweetener in the sweetening composition may be any intense sweetener, and preferably is selected from the group consisting of acesulfame K, aspartame, and mixtures thereof. Thus, in one embodiment, the intense sweetener comprises 0%-100% acesulfame K and 0%-100% aspartame. In another embodiment, the intense sweetener comprises 1%-99% acesulfame K and 1%-99% aspartame. In still another embodiment, the intense sweetener comprises 25%-75% acesulfame K and 25%-75% aspartame. In yet another embodiment, the intense sweetener comprises 40%-60% acesulfame K and 40%-60% aspartame.

The food additive in the sweetening composition comprises an amino acid, an acid selected from organic acids, inorganic acids and mixtures thereof, and a metal ion. The amino acid may be a single amino acid or a mixture of amino acids (including proteins and peptides). Non-limiting representative amino acids which can be used to make the food additive are the free base, salts and hydrates of lysine, ornithine, diaminopimelic acid, and amino acids of the formula: NH₂(CH₂)ₙCOOH in which n is 1 to 6, such as glycine, beta-alanine, 4-aminobutyric acid, 5-aminovaleric acid, 6-aminocaproic acid and 7-aminoheptanoic acid. Some of these amino acids are available as food or pharmaceutical grade ingredients. Non-limiting examples of the metal ion include metal ions such as Group IA ions from the Periodic Table, Group IIA ions from the Periodic Table, titanium, vanadium, chromium, manganese, iron, cobalt, nickel, copper, zinc and selenium. Non-limiting examples of the organic acids are mono-, di-, tri-, polycarboxylic acids (such as acetic, citric, malic, succinic, tartaric and fumaric acid) and may contain other functional groups such as NH₂⁽⁻⁾, OH⁽⁻⁾, PO₄⁽⁻³⁾, and SO₄⁽⁻²⁾. Non-limiting examples of the inorganic acids are hydrochloric acid, sulfuric acid and phosphoric acid.

The molar ratio of metal ion to amino acid to organic/inorganic acid(s) in the food additive can vary depending on the application. The molar ratio of amino acid to metal ion can vary from 0.1 to 20. The organic/inorganic acid(s) to metal ion molar ratio can vary from 0.1 to 20. The most common molar ratio has amino acid varying from 0.1 to 4, and the organic/inorganic acid(s) varying from 0.1 to 4. The specific gravity of the food additive of amino acid, organic/inorganic acid(s), and metal ion source can vary from 1.0 to 1.5 g/ml; the typical value varies 1.2 to 1.3 g/ml. The food additive may be made using the ingredients and the methods described in U.S. Pat. No. 5,766,636, which is incorporated herein by reference. One example food additive for use in a composition according to the invention is sold under the trademark “SUCRELESSE” by Natura, Inc., Lansing, Mich., USA, and comprises the following:

| | | | | |
|---|---|---|---|---|
| Water | 119 | grams | | |
| Lysine HOH | 110 | grams | 0.67 | mole |
| MgO | 18 | grams | 0.45 | mole |
| Malic acid | 94 | grams | 0.70 | mole |
| Citric acid | 44.8 | grams | 0.23 | mole, |

wherein the pH of the solution varies from 4.0 to 4.2 and is an
approximately 65% solution, and the ratio of lysine HOH:metal
oxide:acids is 1.49:1.0:2.07.

Non-limiting examples of the gum used in a sweetening composition according to the invention are pectin, alginate, carboxymethylcellulose, locust bean gum, xanthan gum, gellan gum, guar gum, carrageenan, gum ghatti, karaya gum, tragacanth, gum acacia, gum arabic, gelatin, and mixtures thereof.

The agent that masks or blocks the taste of bitter substances is used to enhance the flavor of a beverage or other oral use product including the sweetening composition and to block and/or mask the bitter taste of substances in a high intensity sweetener (such as the metal ions, e.g., potassium ion from acesulfame K). Any substance that blocks and/or masks the bitter taste of substances (such as metal ions) in the high intensity sweetener without destroying the taste quality of the beverage or other oral use product including the sweetening composition may be suitable for use as the agent that masks or blocks bitter taste. One example bitterness blocking and/or masking agent for use in a composition according to the invention is a mixture of natural flavors sold under the trademark “K-BLOCK” or “K-BLOCK II” by Natura, Inc., Lansing, Mich., USA.

One further example of a sweetening composition according to the invention is the unique combination of an intense sweetener, xanthan gum, a SUCRELESSE™ brand food additive, and a K-BLOCK™ brand bitterness blocking and/or masking agent that is used in a beverage or other oral use product. The components in the sweetening composition other than the intense sweetener improve the shelf life, enhance the mouth-feel, eliminate the off flavors of the high intensity sweeteners, and improve the time-intensity profile of a beverage or other oral use product including the sweetening composition.

The weight percentages of the intense sweetener, the food additive, the agent that masks or blocks the taste of bitter substances, and the gum in the sweetening composition may vary depending on the shelf life, mouth-feel, flavors and time-intensity profile desired in a beverage or other oral product including the sweetening composition. The weight percentages (based on the total weight of the sweetening composition) of the intense sweetener in the sweetening composition may be from about 25% to about 75%. The weight percentages (based on the total weight of the sweetening composition) of the food additive in the sweetening composition may be from about 0% to about 35%, preferably from about 10% to about 35%, and most preferably from about 15% to about 30%. The weight percentages (based on the total weight of the sweetening composition) of the agent that masks or blocks the taste of bitter substances in the sweetening composition may be from about 0% to about 35%, preferably from about 10% to about 35%, and most preferably from about 10% to about 35%. The weight percentages (based on the total weight of the sweetening composition) of the gum in the sweetening composition may be from about 0% to about 35%, preferably from about 10% to about 35%, and most preferably from about 15% to about 30%.

In another embodiment, the present invention is a beverage including a sweetening composition according to the invention. A first embodiment of the beverage includes an intense sweetener comprising a mixture of aspartame and acesulfame K; and a food additive comprising an amino acid, an acid selected from organic acids, inorganic acids and mixtures thereof, and a metal ion. A second embodiment of the beverage includes an intense sweetener; a food additive comprising an amino acid, an acid selected from organic acids, inorganic acids and mixtures thereof, and a metal ion; and an agent that masks or blocks the taste of bitter substances. A third embodiment of the beverage includes an intense sweetener; a food additive comprising an amino acid, an acid selected from organic acids, inorganic acids and mixtures thereof, and a metal ion; and a gum.

A beverage (such as a diet soda) prepared using the sweetening composition of the invention has a time-intensity profile similar to sucrose, better mouth-feel, longer shelf life, and overall better flavor profile than a diet soda prepared with a single high intensity sweetener, such as aspartame, sucralose, acesulfame K, saccharin, and cyclamate. This is accomplished using a gum (xanthan, gelatin, carboxymethylcellulose, pectin, gum arabic, gum acacia and alginate) and a food additive comprising of an amino acid, an organic acid and/or inorganic acid and a metal ion (e.g., SUCRELESSE™), and an agent that masks or blocks the taste of bitter substances (e.g., K-BLOCK™ and/or K-BLOCK™ II, a more concentrated blend). The above combination will allow a diet soda to have blends of high intensity sweeteners, acesulfame K and aspartame, and have the ratio of acesulfame K and aspartame that varies from 5:95 to 100:0 without the off flavors due to the high intensity sweeteners. This will also work with any blends of high intensity sweeteners.

Without intending to be bound by theory, it is believed that the food additive in the sweetening composition acts as a bitter blocker, and enhances mouth-feel. The use of gums in the sweetening composition increases the mouth-feel, but lowers the sweetness and flavor profile of a beverage including the sweetening composition. There is a synergistic effect when the food additive (SUCRELESSE™) is used with gums. For example, there is an enhancement of mouth-feel with a blend of the food additive (SUCRELESSE™) and xanthan gum, compared to them being used separately. Also with the blend of the food additive (SUCRELESSE™) and xanthan gum, the food additive (SUCRELESSE™) prevents the loss of sweetness and flavor profile. The bitterness blocking and/or masking agent (K-BLOCK™) is used to enhance the flavor of a beverage (e.g., diet soda) having the sweetening composition and to block the bitter taste of the potassium ion from the acesulfame K intense sweetener. The bitterness blocking and/or masking agent (K-BLOCK™) and the food additive (SUCRELESSE™) have the synergistic effect of blocking the off flavors like potassium and enhancing the flavors of a beverage having the sweetening composition.

### EXAMPLES

The following Examples have been presented in order to further illustrate the invention and are not intended to limit the invention in any way. Examples 1 to 5 demonstrate the effect that a food additive comprising of an amino acid, an organic acid and/or inorganic acid, and a metal ion (SUCRELESSE™ brand food additive), xanthan gum, and an agent that masks or blocks the taste of bitter substances (K-BLOCK™ and/or K-BLOCK™ II brand bitterness blocking and/or masking agents) have on a diet soda beverage. Example 6 describes the production of a diet cola according to the invention. Example 7 describes the production of diet orange soda according to the invention. Example 8 is a comparative test of a control diet soda and the diet cola and the diet orange soda of Examples 6 and 7.

Example 1 is a control soda having aspartame and was taste tested on a scale of 1 to 9 wherein 1 is worst and 9 is best. Example 1 has a value of 6 and is a commercial product. In Example 2, SUCRELESSE™ brand food additive, xanthan gum and K-BLOCK™ brand bitterness blocking and/or masking agent were added to the control syrup of Example 1 and there was a slight improvement of the diet soda (taste value was 6.5). In Example 3, there was used a blend of acesulfame K and aspartame at a ratio of 70:30 and the blend was at a 30% reduction of the high intensity sweetener compared to Example 1. This control diet soda had the worst taste (taste value was 5). In Example 4, by just using the K-BLOCK™ brand bitterness blocking and/or masking agent in the formula of Example 3, the taste was better than the control (taste value was 7). In Example 5, by adding K-BLOCK™ brand bitterness blocking and/or masking agent, SUCRELESSE™ brand food additive and xanthan gum to a soda having a blend of acesulfame K and aspartame, the drink scored the best overall (taste value of 8 to 8.5).

Example 6 was a production diet cola using SUCRELESSE™ brand food additive, xanthan gum, K-BLOCK™ II brand bitterness blocking and/or masking agent with 60% acesulfame K and 40% aspartame. Example 7 was a production diet orange soda using SUCRELESSE™ brand food additive, xanthan gum, K-BLOCK™ II brand bitterness blocking and/or masking agent with 60% acesulfame K and 40% aspartame. In Example 8, the diet cola of Example 6 and the diet orange soda of Example 7 were found to be superior to a control diet soda.

### Example 1

A control syrup was prepared having the following formula:

| | | |
|---|---|---|
| aspartame | 3.32 | grams |
| potassium benzoate | 3.0 | grams |
| citric acid anhydrous | 1 | gram |
| caffeine | 0.81 | gram |
| cola flavor | 15.4 | ml. |
| water | 1.0 | liter |

These syrups are to be thrown 1+5 and carbonated to 3.8 vols. of gas (used carbonated bottle water to make the drink). Taste test was 6 on a scale 1-9 (1 worst, 9 best).

### Example 2

Example 2 was a 1-liter formula for a diet cola. The formula had 250 ppm SUCRELESSE™ brand food additive, 250 ppm xanthan, 250 ppm K-BLOCK™ brand bitterness blocking and/or masking agent with 100% aspartame. The formula was prepared as follows:

| | | |
|---|---|---|
| aspartame | 3.32 | grams |
| K-BLOCK ™ | 1.5 | grams |
| SUCRELESSE ™ | 1.5 | grams |
| xanthan | 1.5 | grams |
| potassium benzoate | 3.0 | grams |
| citric acid anhydrous | 1 | gram |
| caffeine | 0.81 | gram |
| cola flavor | 15.4 | ml. |
| water | 1.0 | liter |

These syrups are to be thrown 1+5 and carbonated to 3.8 vols. of gas (used carbonated bottle water to make the drink). Taste test was 6.5 on a scale 1-9 (1 worst, 9 best).

### Example 3

Example 3 was a 1-liter formula for diet cola. The formula had 70% acesulfame K and 30% aspartame, and a 30% reduction of sweetener compared to Example 1. The formula was prepared as follows:

| | | |
|---|---|---|
| aspartame | 0.69 | grams |
| acesulfame K | 1.63 | grams |
| potassium benzoate | 3.0 | grams |
| citric acid anhydrous | 1 | gram |
| caffeine | 0.81 | gram |
| cola flavor | 15.4 | ml. |
| water | 1.0 | liter |

These syrups are to be thrown 1+5 and carbonated to 3.8 vols. of gas (used carbonated bottle water to make the drink). Taste test was 5 on a scale 1-9 (1 worst, 9 best).

### Example 4

Example 4 was a 1-liter formula for diet cola. The formula had 250 ppm K-BLOCK™ brand bitterness blocking and/or masking agent with 70% acesulfame K and 30% aspartame, and a 30% reduction of sweetener compared to Example 1. The formula was prepared as follows:

| | | |
|---|---|---|
| aspartame | 0.69 | grams |
| acesulfame K | 1.63 | grams |
| K-BLOCK ™ | 1.5 | grams |
| potassium benzoate | 3.0 | grams |
| citric acid anhydrous | 1 | gram |
| caffeine | 0.81 | gram |
| cola flavor | 15.4 | ml. |
| water | 1.0 | liter |

These syrups are to be thrown 1+5 and carbonated to 3.8 vols. of gas (used carbonated bottle water to make the drink). Taste test was 7 on a scale 1-9 (1 worst, 9 best).

### Example 5

### One Liter Formula and Production Run

Example 5 was a 1-liter formula for diet cola. The formula had 250 ppm SUCRELESSE™ brand food additive, 250 ppm xanthan, 250 ppm K-BLOCK™ brand bitterness blocking and/or masking agent with 70% acesulfame K and 30% aspartame, and a 30% reduction of sweetener compared to Example 1. The formula was prepared as follows:

| | | | | | | |
|---|---|---|---|---|---|---|
| SUCRELESSE ™ | 1.5 | grams | 3.69 | kg | 8.14 | pound |
| potassium benzoate | 1.71 | grams | 4.21 | kg | 9.3 | pounds |
| citric acid, anhydrous | 1.03 | gram | 2.53 | kg | 5.6 | pounds |
| aspartame | 0.69 | grams | 1.69 | kg | 3.73 | pounds |
| acesulfame K | 1.63 | grams | 4.01 | kg | 8.84 | pounds |
| caffeine | 0.81 | grams | 1.99 | kg | 4.39 | pounds |
| K-BLOCK ™ | 1.5 | grams | 3.69 | kg | 8.14 | pounds |
| diet cola Flavor | 15.4 | mls. | 37.89 | L | 10 | gallons |
| xanthan gum- | 1.5 | grams | 3.69 | kg | 8.14 | pounds |
| prehydrated | | | | | | |
| Total volume | 1 | liter | 850 | gallons | 850 | gallons |

These syrups are to be thrown 1+5 and carbonated to 3.8 vols. of gas (used carbonated bottle water to make the drink). Taste test was 8-8.5 on a scale 1-9 (1 worst, 9 best)

### Example 6

### Production Run

Example 6 was a 1-liter formula for diet cola. The formula had 250 ppm SUCRELESSE™ brand food additive, 250 ppm xanthan, 125 ppm K-BLOCK™ II brand bitterness blocking and/or masking agent with 60% acesulfame K and 40% aspartame, and a 30% reduction of sweetener compared to Example 1. The formula was prepared as follows:

| | | | | | | |
|---|---|---|---|---|---|---|
| SUCRELESSE ™ | 1.5 | grams | 3.69 | kg | 8.14 | pounds |
| potassium benzoate | 1.71 | grams | 4.21 | kg | 9.3 | pounds |
| citric acid, anhydrous | 1.03 | gram | 2.53 | kg | 5.6 | pounds |
| aspartame | 0.93 | grams | 2.29 | kg | 5.05 | pounds |
| acesulfame K | 1.39 | grams | 3.42 | kg | 7.54 | pounds |
| caffeine | 0.81 | grams | 1.99 | kg | 4.39 | pounds |
| K-BLOCK ™ II | 0.75 | grams | 1.85 | kg | 4.08 | pounds |
| diet cola/acid | 15.4 | mls. | 37.89 | L | 10 | gallons |
| xanthan gum- | 1.5 | grams | 3.69 | kg | 8.14 | pounds |
| prehydrated | | | | | | |
| Total volume | 1 | liter | 650 | gallons | 650 | gallons |

### Example 7

### Production Run

Example 7 was a 1 liter formula for diet orange soda. The formula had 250 ppm SUCRELESSE™ brand food additive, 250 ppm xanthan, 125 ppm K-BLOCK™ II brand bitterness blocking and/or masking agent with 60% acesulfame K and 40% aspartame, and 30% reduction of sweetener compared to Example 1. The formula was prepared as follows:

| | | | | | | |
|---|---|---|---|---|---|---|
| SUCRELESSE ™ | 1.5 | grams | 3.69 | kg | 8.14 | pounds |
| potassium benzoate | 2.49 | grams | 6.13 | kg | 13.5 | pounds |
| potassium citrate | 1.85 | gram | 4.55 | kg | 10 | pounds |
| citric acid, anhydrous | 6.64 | gram | 16.34 | kg | 36 | pounds |
| aspartame | 0.82 | grams | 2.02 | kg | 4.45 | pounds |
| acesulfame K | 1.24 | grams | 3.05 | kg | 6.73 | pounds |
| K-BLOCK ™ II | 0.75 | grams | 1.85 | kg | 4.08 | pounds |
| orange flavor | 12.3 | mls. | 30.26 | L | 8 | gallons |
| xanthan gum- | 1.5 | grams | 3.69 | kg | 8.14 | pounds |
| prehydrated | | | | | | |
| Total volume | 1 | liter | 650 | gallons | 650 | gallons |

### Example 8

### Comparative Test

A comparative taste test was performed using the sodas of Examples 6 and 7 after refrigeration at 40° F. for one year and a control diet cola having 100% aspartame, similar to Example 1. After tasting the sodas of Examples 6 and 7 and the control diet cola having 100% aspartame, it was clear both from a flavor point of view and sweetener point of view that the sodas of Examples 6 and 7 were superior to the control diet cola having 100% aspartame. The sweetness level was at least 15% higher and possibly more than the control soda. This level was arrived at since the human tongue has difficulty distinguishing closer levels. The difference in the control soda and Examples 6 and 7 was obvious. Therefore, it was at least that much sweeter.

The other obvious thing which was noticeable was the quality of the flavor. There seemed to be very little degradation of the flavor in Examples 6 and 7. The “fresh” character was attributed to either the K-BLOCK™ agent that masks or blocks the taste of bitter substances in the formula and/or the Sucrelesse™ food additive. That information was deemed important since both cola and the orange flavors are citrus based. The implication was that one or both of those ingredients has enhanced and preserved the integrity of those flavoring systems. The orange was tasted monadically since an orange control was not used, but the sweetness and the flavor were deemed to be fine and remarkable after that period of storage. What was obvious was the lack of rancidity usually associated with orange oil formulations. Examples 6 and 7 tasted more like sugar which surprising in a diet soda.

Therefore, it can be seen that there has been provided a sweetening composition having an intense sweetener that may be incorporated into a beverage or other oral use product in order to improve the shelf life, enhance the mouth-feel, eliminate the off flavors of high intensity sweeteners, and improve the time-intensity profile of high intensity sweetener and blends of high intensity sweeteners in the beverage or other oral use product. While the composition has been illustrated as improving the taste of a food product having aspartame and/or acesulfame K, it is contemplated that the composition would also improve the taste of a food product having other intense sweeteners such as saccharin, cyclamates, stevioside, glycyrrhizin, dipotassium glycyrrhizin, glycyrrhizic acid ammonium salt, and thaumatin.

Furthermore, the composition would be suitable for use in any composition for oral use including, without limitation, foods or beverages (e.g., a gelatin dessert or pudding, or dry-mix therefor, a confection or chewing gum, a flavored carbonated drink, a fruit flavored non-carbonated drink or dry-mix therefor, a canned or preserved fruit or fruit juice, or a baked product such as a cake or cookie), a solution or dry powder for use as a table sweetener (i.e. for sweetening edible foods and beverages at the point of consumption), oral hygienic products (such as mouth wash, tooth paste and tooth powder) and formulated medicinal agents (particularly solutions or suspensions for pediatric use).

Although the present invention has been described with reference to certain embodiments, one skilled in the art will appreciate that the present invention can be practiced by other than the described embodiments, which have been presented for the purpose of illustration and not of limitation. Therefore the scope of the appended claims should not be limited to the description of the embodiments contained herein.

What is claimed is:

1. A sweetening composition for oral use, the composition comprising:
an intense sweetener comprising a mixture of aspartame and acesulfame K; and
a food additive comprising an amino acid, an acid selected from organic acids, inorganic acids and mixtures thereof, and a metal ion.

2. The composition of claim 1 further comprising:
an agent that masks or blocks the taste of bitter substances.

3. The composition of claim 2 wherein the agent that masks or blocks the taste of bitter substances comprises:
a mixture of natural flavors.

4. The composition of claim 2 wherein:
the agent that masks or blocks the taste of bitter substances blocks the bitter taste of metal ions.

5. The composition of claim 1 further comprising:
a gum.

6. The composition of claim 5 wherein
the gum is selected from the group consisting of pectin, alginate, carboxymethylcellulose, locust bean gum, xanthan gum, gellan gum, guar gum, carrageenan, gum ghatti, karaya gum, tragacanth, gum acacia, gum arabic, gelatin, and mixtures thereof.

7. The composition of claim 5 wherein the gum is xanthan.

8. The composition of claim 1 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

9. The composition of claim 1 wherein:
the molar ratio of the amino acid to the metal ion in the food additive is from 0.1 to 20, and
the molar ratio of the acid selected from organic acids, inorganic acids and mixtures thereof to the metal ion in the food additive is from 0.1 to 20.

10. The composition of claim 1 wherein:
the food additive comprises lysine, malic acid, citric acid and magnesium ions.

11. The composition of claim 1 wherein:
the intense sweetener comprises 25%-75% acesulfame K and 25%-75% aspartame.

12. The composition of claim 11 wherein:
the intense sweetener comprises 40%-60% acesulfame K and 40%-60% aspartame.

13. A sweetening composition for oral use, the composition comprising:
an intense sweetener;
a food additive comprising an amino acid, an acid selected from organic acids, inorganic acids and mixtures thereof, and a metal ion; and
an agent that masks or blocks the taste of bitter substances.

14. The composition of claim 13 wherein the agent that masks or blocks the taste of bitter substances comprises:
a mixture of natural flavors.

15. The composition of claim 13 wherein:
the agent that masks or blocks the taste of bitter substances blocks the bitter taste of metal ions.

16. The composition of claim 13 further comprising:
a gum.

17. The composition of claim 16 wherein the gum is selected from the group consisting of pectin, alginate, carboxymethylcellulose, locust bean gum, xanthan gum, gellan gum, guar gum, carrageenan, gum ghatti, karaya gum, tragacanth, gum acacia, gum arabic, gelatin, and mixtures thereof.

18. The composition of claim 16 wherein the gum is xanthan.

19. The composition of claim 13 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

20. The composition of claim 13 wherein:
the molar ratio of the amino acid to the metal ion in the food additive is from 0.1 to 20, and
the molar ratio of the acid selected from organic acids, inorganic acids and mixtures thereof to the metal ion in the food additive is from 0.1 to 20.

21. The composition of claim 13 wherein:
the food additive comprises lysine, malic acid, citric acid and magnesium ions.

22. The composition of claim 13 wherein:
the intense sweetener comprises 0%-100% acesulfame K and 0%-100% aspartame.

23. The composition of claim 13 wherein:
the intense sweetener comprises 25%-75% acesulfame K and 25%-75% aspartame.

24. A sweetening composition for oral use, the composition comprising:
an intense sweetener;
a food additive comprising an amino acid, an acid selected from organic acids, inorganic acids and mixtures thereof, and a metal ion; and
a gum.

25. The composition of claim 24 wherein
the gum is selected from the group consisting of pectin, alginate, carboxymethylcellulose, locust bean gum, xanthan gum, gellan gum, guar gum, carrageenan, gum ghatti, karaya gum, tragacanth, gum acacia, gum arabic, gelatin, and mixtures thereof.

26. The composition of claim 25 wherein the gum is xanthan.

27. The composition of claim 25 further comprising:
an agent that masks or blocks the taste of bitter substances.

28. The composition of claim 27 wherein:
the agent that masks or blocks the taste of bitter substances blocks the bitter taste of metal ions.

29. The composition of claim 24 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

30. The composition of claim 24 wherein:
the molar ratio of the amino acid to the metal ion in the food additive is from 0.1 to 20, and
the molar ratio of the acid selected from organic acids, inorganic acids and mixtures thereof to the metal ion in the food additive is from 0.1 to 20.

31. The composition of claim 24 wherein:
the food additive comprises lysine, malic acid, citric acid and magnesium ions.

32. The composition of claim 24 wherein:
the intense sweetener comprises 0%-100% acesulfame K and 0%-100% aspartame.

33. The composition of claim 24 wherein:
the intense sweetener comprises 25%-75% acesulfame K and 25%-75% aspartame.

34. A beverage comprising:
an intense sweetener comprising a mixture of aspartame and acesulfame K; and
a food additive comprising an amino acid, an acid selected from organic acids, inorganic acids and mixtures thereof, and a metal ion.

35. The beverage of claim 34 further comprising:
an agent that masks or blocks the taste of bitter substances.

36. The beverage of claim 35 wherein the agent that masks or blocks the taste of bitter substances comprises:
a mixture of natural flavors.

37. The beverage of claim 34 further comprising:
a gum.

38. The beverage of claim 37 wherein the gum is xanthan.

39. The beverage of claim 34 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

40. The beverage of claim 34 wherein:
the food additive comprises lysine, malic acid, citric acid and magnesium ions.

41. The beverage of claim 34 wherein:
the intense sweetener comprises 25%-75% acesulfame K and 25%-75% aspartame.

42. A beverage comprising:
an intense sweetener;
a food additive comprising an amino acid, an acid selected from organic acids, inorganic acids and mixtures thereof, and a metal ion; and
an agent that masks or blocks the taste of bitter substances.

43. The beverage of claim 42 wherein the agent that masks or blocks the taste of bitter substances comprises:
a mixture of natural flavors.

44. The beverage of claim 43 further comprising:
a gum.

45. The beverage of claim 44 wherein the gum is xanthan.

46. The beverage of claim 42 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

47. The beverage of claim 42 wherein:
the intense sweetener comprises 0%-100% acesulfame K and 0%-100% aspartame.

48. A beverage comprising:
an intense sweetener;
a food additive comprising an amino acid, an acid selected from organic acids, inorganic acids and mixtures thereof, and a metal ion; and
a gum.

49. The beverage of claim 48 further comprising:
an agent that masks or blocks the taste of bitter substances comprising a mixture of natural flavors.

50. The beverage of claim 48 wherein:
the gum is selected from the group consisting of pectin, alginate, carboxymethylcellulose, locust bean gum, xanthan gum, gellan gum, guar gum, carrageenan, gum ghatti, karaya gum, tragacanth, gum acacia, gum arabic, gelatin, and mixtures thereof.

51. The beverage of claim 50 wherein the gum is xanthan.

52. The beverage of claim 48 wherein:
the acid selected from organic acids, inorganic acids and mixtures thereof is selected from monocarboxylic acids, dicarboxylic acids, tricarboxylic acids, polycarboxylic acids and mixtures thereof; and
the metal ion is selected from Group IA ions from the Periodic Table, Group IIA ions from the Periodic Table, titanium, vanadium, chromium, manganese, iron, cobalt, nickel, copper, zinc, selenium and mixtures thereof.

53. The beverage of claim 48 wherein:
the intense sweetener comprises 0%-100% acesulfame K and 0%-100% aspartame.
